(19) United States
(12) Patent Application Publication
(10) Pub. No.: US 2013/0093913 A1
(43) Pub. Date: Apr. 18, 2013

(54) INFORMATION PROCESSING APPARATUS, DISPLAY METHOD, AND INFORMATION PROCESSING SYSTEM

(71) Applicants: Atsushi Okumura, Osaka (JP); Hitoshi Yamamoto, Hyogo (JP)

(72) Inventors: Atsushi Okumura, Osaka (JP); Hitoshi Yamamoto, Hyogo (JP)

(73) Assignee: RICOH COMPANY, LTD., Tokyo (JP)

(21) Appl. No.: 13/650,196

(22) Filed: Oct. 12, 2012

(30) Foreign Application Priority Data
Oct. 17, 2011 (JP) 2011-228070

(51) Int. Cl. H04N 5/225

(52) U.S. Cl. 348/222.1

(57) ABSTRACT

An information processing apparatus displaying a desired image includes an acquisition unit acquiring image data transmitted from a device connected to the information processing apparatus; and a scale conversion unit enlarging the acquired image data in accordance with a requested image size.

### CROSS-REFERENCE TO RELATED APPLICATIONS

The present application claims priority under 35 U.S.C §119 to Japanese Patent Application No. 2011-228070 filed Oct. 17, 2011, the entire contents of which are hereby incorporated herein by reference.

### BACKGROUND OF THE INVENTION

1. Field of the Invention

The present invention generally relates to an information processing apparatus displaying image data, a display method of displaying the image data, and an information processing system including the information processing apparatus.

2. Description of the Related Art

Recently, a portable video recording and reproducing apparatus has become more and more popular such as a compact video camera, a digital camera, a cellular phone having a camera function and the like carrying a camera imaging device. With recent technical progress in improving the image quality, even such a portable video recording and reproducing apparatus has been able to display a high-quality video or image with higher resolution. However, such an apparatus has no specific function to, for example, prevent the shooting of video data. This means that high-quality video and images may be displayed only by, for example, pushing the shooting button of the apparatus (camera). Therefore, a person may be easily identified and privacy may not be fully secure.

### SUMMARY OF THE INVENTION

According to an aspect of the present invention, an information processing apparatus displaying a desired image includes an acquisition unit acquiring image data transmitted from a device connected to the information processing apparatus; and a scale conversion unit enlarging the acquired image data in accordance with a requested image size.

### BRIEF DESCRIPTION OF THE DRAWINGS

Other objects, features, and advantages of the present invention will become more apparent from the following description when read in conjunction with the accompanying drawings, in which:

FIG. 1 is a drawing illustrating example images displayed according to an embodiment;

FIG. 2 is a block diagram illustrating an example configuration of a system in a related art;

FIG. 3 is a block diagram illustrating an example configuration of a system in a related art containing a mosaic function;

FIG. 4 is a block diagram illustrating another example configuration of a system in a related art containing the mosaic function;

FIG. 5 is a block diagram illustrating an example configuration of a system according to an embodiment;

FIG. 6 is a functional block diagram illustrating an example configuration of a system according to an embodiment;

FIG. 7 is an example flowchart illustrating operations of an information processing apparatus according to an embodiment;

FIG. 8 is a drawing illustrating a state of USB data in a case of a normal image;

FIG. 9 is a drawing illustrating a state of USB data in a case of an 8×8 pixel tile mosaic image; and

FIG. 10 is a drawing illustrating a state of USB data in a case of a 22×22 pixel tile mosaic image.

### DETAILED DESCRIPTION OF THE PREFERRED EMBODIMENTS

With a recent technical progress in improving the image quality, even a portable video recording and reproducing apparatus has been able to display a high-quality video or image with higher resolution.

Therefore, it is desired that such an apparatus has a privacy protection function that makes it difficult to identify a person displayed in an image imaged (captured) by a USE (Universal Serial Bus) camera and the like.

The present invention is made in light of the above, and may provide an information processing apparatus containing the privacy protection function that makes it difficult to identify a person in an image and a display method including the privacy protection function.

Therefore, according to an embodiment of the present invention, it may become possible to display an image where it is difficult to identify a person on the image.

In the following, preferred embodiments of the present invention are described with reference to the accompanying drawings. In the description and the figures of the present application, the same reference numerals are used to describe the elements having substantially the same functional configurations, and the repeated description thereof may be herein omitted.

Recently, it have become possible for a portable video recording and reproducing apparatus to display a high-quality video or image with higher resolution. As a result, however, it has also become easier to identify an individual (person) displayed in an image, and privacy may not be fully protected.

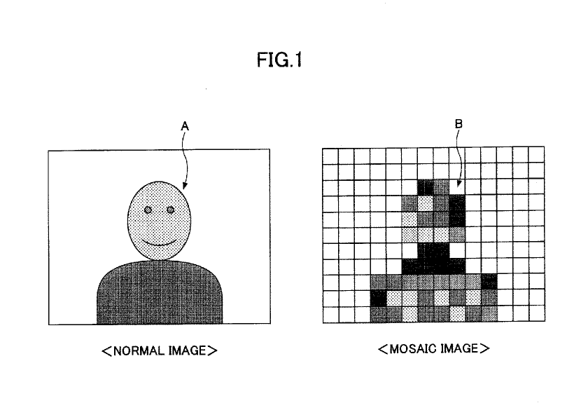

The left-hand side of FIG. 1 illustrates an example of a normal image “A” imaged (captured) by a camera. As illustrated in the left-hand side of FIG. 1, it is easy to identify the individual in the image. To prevent easy identification, there is a privacy protection function. The privacy protection function refers to a function to protect an individual's privacy by performing a specific imaging process on an image to be displayed in a manner such that an object in the image may be recognized as a person but it is not possible to identify who is the person. The right-hand side of FIG. 1 illustrates an example of a mosaic image “B”. The mosaic image is generated by determining image data to be in one pixel based on image data of the pixel and plural adjacent pixels, so that it is possible to recognize that there is a person in the image but it is not possible to recognize (identify) who is the person in the image. When an apparatus has the privacy protection function, it is possible to convert a normal image into a mosaic image to display the mosaic image. Therefore, such an apparatus may be useful as an apparatus having both a privacy protection capability and convenience.

In the following, a display system in a related art without the privacy protection function and a display system in a related art including the privacy protection function are first described. Then, a display system having the privacy protection function according to an embodiment of the present application is described.

### Display System in a Related Art

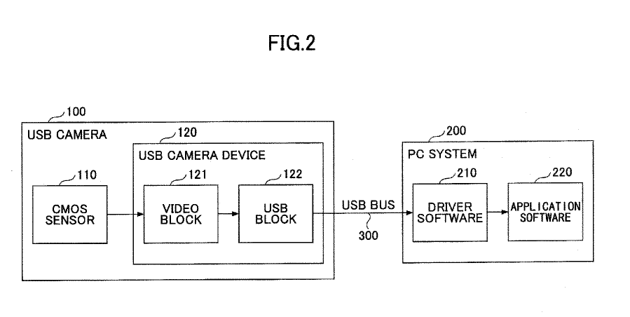

First, an example configuration of the display system in a related art displaying an image imaged by a USB camera is described with reference to FIG. 2. FIG. 2, illustrates a display system in a related art where a USB camera 100 is connected to a PC (Personal Computer) system 200.

In the display system, the USB camera 100 is connected to the PC system 200 via a USB bus 300. The USB camera 100 includes a CMOS (Complementary Metal Oxide Semiconductor) sensor 110 and a USB camera device 120. The USB camera device 120 includes a video block 121 and a USE block 122. The PC system 200 includes driver software 210 and application software 220. The driver software 210 and the application software 220 are provided as a software package.

First, when the USB camera device 120 of the USB camera 100 is connected to the PC system 200, all the image-size information items and all the image format information items corresponding to (supported by) the USB camera are reported to the driver software 210 of the PC system 200 via the USB bus 300.

When the application software 220 of the PC system 200 is intended to preview the image acquired from the USB camera 100 on the screen, the driver software 210 acquires all the image-size information items and all the image format information items supported by the USB camera. Then, the application software 220 specifies (designates) an image size and an image format to be currently used for the preview from among the acquired information items, and outputs a transmission request to transmit the image data.

The driver software 210 reports the image size and the image format designated by the application software 220 to the USB camera device 120, and requests the transmission of the image data. The video block 121 of the USB camera device 120 performs an imaging process on the image data acquired from the CMOS sensor 110 so as to correspond to the image size and the image format designated by the application software 220. Then, the image data are transmitted to the USB bus 300 via the USB block 122 of the USB camera device 120. In this case, the image format typically used in the video block 121 is YUV4:2:2. Further, the video block 121 includes a scaling circuit (not shown), so that the scaling circuit changes the image size to the designated image size.

The video block 121 further includes an MJPEG (Motion Joint Photographic Expert Group) hardware encoder circuit (not shown). When the MJPEG is designated as the image format, the MJPEG hardware encoder circuit converts the YUV4:2:2 data into MJPEG data, and outputs the MJPEG data. The control including the format conversion in the video block 121 is realized by executing firmware (software) stored in a memory (not shown) by a CPU (Central Processing Unit) (not shown) included in the USB camera device 120.

### System in Related Art (Mosaic Function 1)

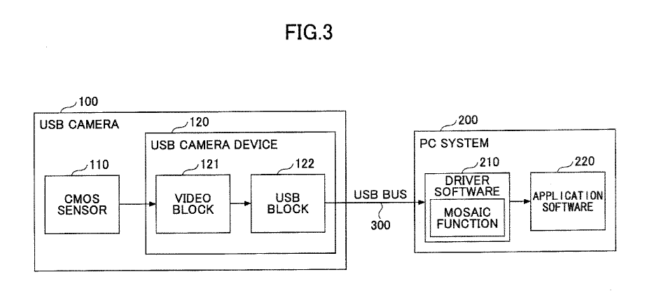

Next, a mosaic function performed (employed) in a system in a related art is described with reference to FIG. 3. As illustrated in FIG. 3, a normal (actual, smooth) image is transmitted from the USB camera 100 to the PC system 200 via the USB bus 300. The driver software 210 performs a mosaic process (mosaic function) on the transmitted normal image to generate a mosaic image (an image including a mosaic image part on which the mosaic process has been performed), and outputs the generated mosaic image to the application software 220. As an example of the mosaic process performed by the driver software 210, an average value of all the pixels within a mosaic part having, for example, a rectangular shape is applied to all the pixels. Otherwise, for example, data of the pixel at the upper left corner of the mosaic part having the rectangular shape may be applied to the data of all the pixels within the mosaic part.

The image on which the mosaic process is performed by the driver software 210 (i.e., the mosaic image) is output to the application software 220. By doing in this way, it may become possible to preview the mosaic image using the application software 220.

In the configuration of the system, the privacy in the preview image may be protected by converting the image to be previewed into the mosaic image. However, the data transmitted on the USB bus 300 is not the mosaic image but the normal image. Therefore, for example, when the PC system 200 is infected with a malicious software program, the normal image transmitted via the USB bus 300 may be stolen. Therefore, in this type of system, privacy may not be fully protected and there is a security hazard to be addressed.

Further, when the designated image format is YUV4:2:2, there is no problem because the normal image may be converted into the mosaic image using the mosaic function of the driver software 210. However, if the designated image format is that for the MJPEG image, due to an image compression format, there exists a problem described below. Namely, if the designated image format is that for the MJPEG image, after the normal image having the MJPEG format is input by the driver software 210, the driver software 210 first decodes and converts the data format from MJPEG into YUV4:2:2. Then, after the driver software 210 performs the mosaic process on the decoded YUV4:2:2 image, it is necessary for the driver software 210 to encode and convert the data format from YUV4:2:2 into MJPEG. However, when those processes are to be performed, the workload (load factor) of the CPU is extremely increased. Therefore, it is difficult to employ this system (method).

### System in Related Art (Mosaic Function 2)

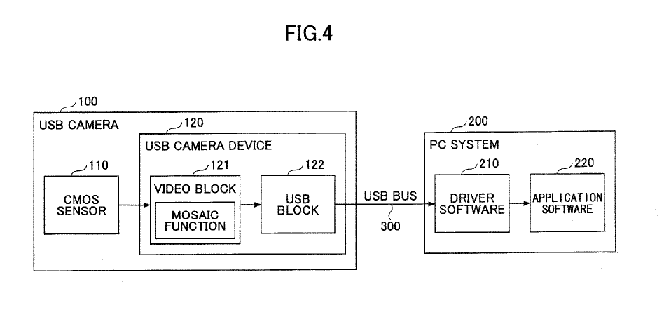

Next, another mosaic function performed (employed) in a system in a related art is described with reference to FIG. 4. The configuration of the system illustrated in FIG. 4 is similar to that of FIGS. 2 and 3 except that the mosaic function is provided as hardware in the video block 121 of the USB camera device 120.

In the system configuration of FIG. 4, the data to be transmitted through the USB bus 300 may be the mosaic image. Therefore, in the system configuration of FIG. 4, the security hazard as described with reference to the system configuration of FIG. 3 may be avoided even when the PC system 200 is infected with a malicious software program.

Further, in a case where the designated image format is the MJPEG image format and the data format conversion is necessary, first, the mosaic process is performed on the normal image in the YUV4:2:2 format in the video block 121. Then, hardware encoding is performed to acquire an image in the MJPEG format. Therefore, the image data to be transmitted to the PC system 200 via the USB bus 300 have the MJPEG format on which the mosaic process has been performed (mosaic MJPEG format). Accordingly, it may become possible to ensure the security even when it is necessary to convert the data format into the MJPEG format. To that end, it is necessary for the video block 121 of the USB camera device 120 to perform the mosaic process (function). However, to perform the mosaic process (function) in the video block 121, the video block 121 may need to have more line buffer and hardware logic than the video block 121 where it is not necessary to perform the mosaic process (function). Therefore, the cost of this system may be increased due to the implementation of the mosaic function in the video block 121.

To resolve at least one of the problems described above, according to an embodiment of the present application, a system is provided that may prevent a person from being identified based on an image transmitted on the USB bus 300 and privacy may also be secured even when the PC system 200 is infected with a malicious software program and the cost of the system (product) may not be increased.

### Configuration of System

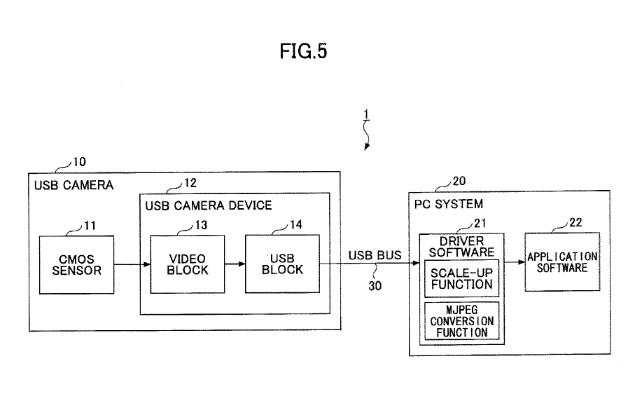

An example configuration of a system according to an embodiment is described with reference to FIG. 5. FIG. 5 illustrates an example configuration of a display system 1 according to an embodiment. In the configuration of the display system 1, the functions of the driver software in the PC system and the firmware (software) for controlling the USB camera device are different from those in the system in the related art illustrated in FIG. 1. However, the rest of the hardware configuration of the display system 1 is substantially the same as that of the system in the related art illustrated in FIG. 1.

As illustrated in FIG. 5, the display system 1 according to an embodiment includes a USB camera 10 and a PC system 20, which are connected to each other via a USB bus 30. The USB camera 10 is an example of a device having an imaging function. The device having the imaging function is not limited to the USB camera 10, and may be a real-time camera such as a Web camera, or may be a card-size (movie) camera, a digital camera, a cellular phone having a camera function or the like. The USB camera 10 may be connected to the PC system 20 by inserting a USB port of the USB camera 10 into a USB port of the PC system 20. By doing this, it becomes possible to transmit the data such as image data to the PC system 20 via the USB bus 30.

The USB camera 10 includes a CMOS (Complementary Metal Oxide Semiconductor) sensor 11 and a USB camera device 12. As described above, the device having the imaging function includes not only a camera imaging device but also a camera device (i.e., the USB camera device 12 in FIG. 5). In the display system 1 according to this embodiment, the USB camera 10 includes the USB camera device 12, and security is improved by using driver software 21.

Here, the PC system 20 is an example of an information processing apparatus displaying a desired image. The information processing apparatus is not limited to the PC and may be any device capable of performing a mosaic process on a desired image. For example, the information processing apparatus may be a TV set, a tablet terminal, and a game device which are capable of performing the mosaic process.

The PC system 20 includes driver software 21 and application software 22. In this embodiment, the driver software 21 includes a scale-up function and an MJPEG conversion function.

First, when the USB camera device 12 is connected to the PC system 20, all the image-size information items and all the image format information items supported by the USE camera 10 are reported to the driver software 21 in the PC system 20 via the USE bus 30. The application software 22 in the PC system 20 acquires an image from the USB camera 10. When the image is to be reviewed, the application software 22 acquires the image-size information items and the image format information items supported by the USB camera 10 from the driver software 21. Then, the application software 22 designates (selects) the image size and the image format for the current review from among the acquired image-size information items and the image format information items. Then, the application software 22 reports the designated image size and the image format to the driver software 21, and outputs a request for the transmission of the image data. The driver software 21 reports the image size and the image format designated by the application software 22 to the USB camera device 12, and requests the transmission of the image data. The USE camera device 12 causes a video block 13 to perform a format conversion process on an image data acquired by the CMOS sensor 11 so that the image size and the image format of the image data correspond to the designated size and the image format, respectively. Then, the USB camera device 12 causes the video block 13 to transmit the converted image data to the USB bus 30 via a USB block 14. In this case, a typical video format used in the video block 13 is YUV4:2:2. The video block 13 includes a scaling circuit not shown), so that the scaling circuit changes the size of the image to the designated size.

The video block 13 further includes an MJPEG hardware encoder circuit (not shown). When MJEPG is selected as the image format, the MJPEG hardware encoder circuit converts YUV4:2:2 data into MJPEG data, and outputs the converted MJPEG data. Such control of the USB camera device 12 is executed by executing firmware/software by an embedded CPU (not shown).

### Functional Configuration of System

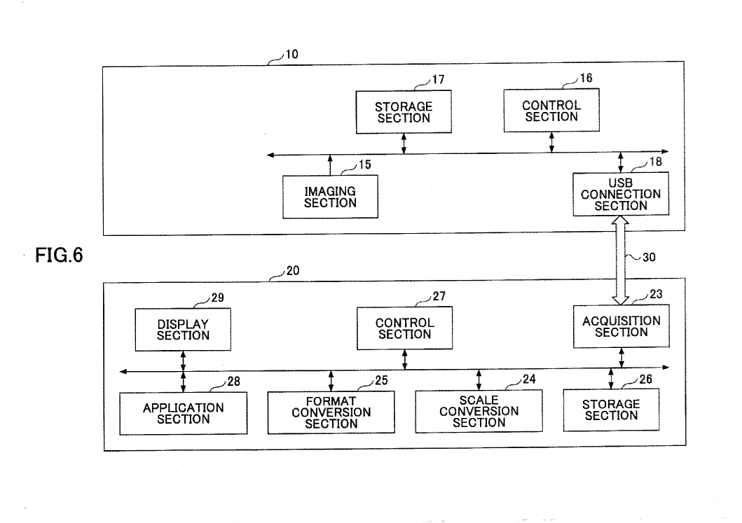

Next, functional configurations of the USB camera 10 and the PC system 20 are described with reference to FIG. 6. FIG. 6 illustrates a functional configuration (block diagram) of the display system 1 according to an embodiment.

As illustrated in FIG. 6, the USB camera 10 includes an imaging section 15, a control section 16, a storage section 17, and a USB connection section 18. The imaging section 15 images an object by using the CMOS sensor 11. The CMOS sensor 11 is an example of the imaging section 15. Instead of the CMOS sensor 11, a CCD (Charge Coupled Device) or the like may be used.

The control section 16 controls the entire USB camera device 12. The storage section 17 stores the image imaged by the imaging section 15, the image size, and the image format of an object. The USE connection section 18 includes a USB connector to be connected to a USB port (not shown) provided in the PC system 20. The control section 16, the storage section 17, and the USB connection section 18 belong to the functions of the USE camera device 12.

On the other hand, the PC system 20 includes an acquisition section 23, a scale conversion section 24, a format conversion section 25, a storage section 26, a control section 27, an application section 28, and a display section 29.

The acquisition section 23 acquires the image data transmitted from the USB camera 10. Specifically, the acquisition section 23 acquires the image data of the object, the image having been imaged by the USB camera 10 and having been transmitted from the USB camera 10 via the USB bus 30.

The scale conversion section 24 enlarges the acquired image data in accordance with the requested scale (i.e., image size). By doing this, the scale conversion section 24 generates a mosaic image based on the image data.

The format conversion section 25 converts the format of the enlarged image having been enlarged in accordance with the requested scale. The storage section 26 stores the image data acquired by the acquisition section 23.

The control section 27 controls the entire operations of the PC system 20. The application section 28 controls the image to be displayed on the display section 29. Specifically, for example, the application section 28 controls in a manner that the image enlarged in accordance with the requested scale can be displayed on the display section 29 in accordance with the requested scale.

Here, the acquisition section 23, the scale conversion section 24, the format conversion section 25, the storage section 26, and the control section 27 belong to the functions of the driver software 21 of the PC system 20. Specifically, the scale conversion section 24 realizes the scale-up function of the driver software 21. Further, the format conversion section 25 realizes the MJPEG conversion function of the driver software 21. The application section 28 realizes a function of the application software 22 of the PC system 20.

### Operations of Sections

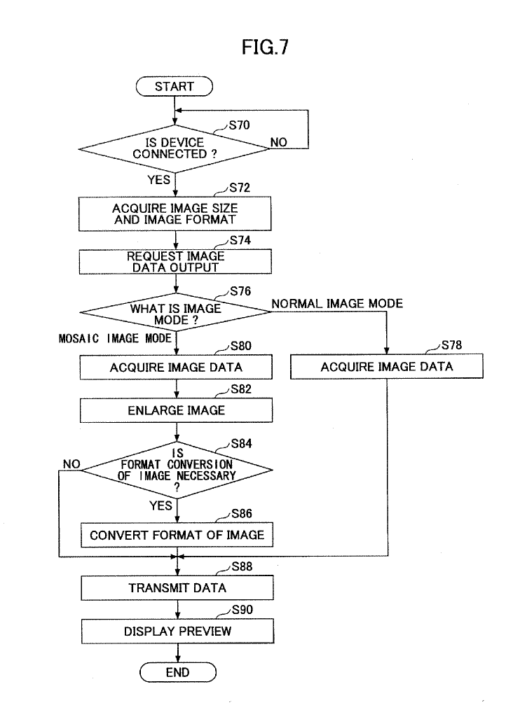

Next, an image processing and a display operation by the driver software 21 of the PC system 20 and the firmware of the USB camera device 12 are described with reference to the flowchart of FIG. 7.

Here, it is assumed that either a normal image mode or a mosaic image mode is set in advance before the operations. There may be at least two methods possible for the user to select either the normal image mode or the mosaic image mode.

In a first selection method, there is a switch provided on the USB camera 10 and the state of the switch is detected by using an interrupt signal of a GPIO (General Purpose Input/Output) signal (not shown) of the USB camera device 12. Based on the state of the GPIO signal the firmware/software of the USB camera device 12 may determine whether the user requests to display the current normal image or display a mosaic image. Further, the driver software 21 of the PC system 20 may also detect whether the user requests the normal image mode or the mosaic image mode by acquiring the current state of the GPIO signal from the USB camera device 12 via the USB bus 30.

In a second selection method, based on any kind of switching operation with respect to the PC system 20 by the user, the driver software 21 recognizes (detects) whether the user requests the current normal image display or mosaic image display. In this case as well, by writing (transmitting) the information indicating whether the user requests the current normal image display or mosaic image display in the USE camera device 12 by the driver software 21 via the USB bus 30, it becomes possible for the firmware/software in the USB camera device 12 to recognize whether the user requests the current normal image display or mosaic image display.

Therefore, it is possible for both the driver software 21 in the PC system 20 and the firmware/software in the USB camera device 12 to recognize which of the current normal image or the mosaic image is to be output before the operations illustrated in FIG. 7 start.

When the imaging process of FIG. 7 starts, it is determined whether the USB camera device 12 is connected to the PC system 20 (step S70).

When determining that the USB camera device 12 is connected to the PC system 20 (YES in step S70), the PC system 20 recognizes (the connection of) the USB camera device 12 and confirms (determines) that the USB camera device 12 is connected to the PC system 20. Next, the driver software 21 (the acquisition section 23) acquires corresponding image size and corresponding image format from the USB camera device 12 via the USB bus 30 (step S72). In this embodiment, it is assumed that four types of formats, which are HD/YUV4:2:2, VGA/YUV4:2:2, HD/MJPEG, and VGA/MJPEG formats, are supported.

In the image size, the term “HD” refers to 1280 by 720 pixels, and the term “VGA” refers to 640 by 480 pixels. In response to the preview request of the image size/image format of the application software 22 of the PC system 20, the driver software 21 (the control section 27) sends an output request to the firmware of the USB camera device 12 to output the image data via the USB bus 30 (step S74). Next, the firmware (the control section 16) of the USB camera device 12 determines whether the image mode is the normal image mode or the mosaic image mode (step S76).

When determining that the normal image mode is selected, the firmware (the control section 16) transmits the image data to the USB bus 30. The driver software 21 (the acquisition section 23) acquires the image data from the firmware (step S78), and transmits the image data to the application software 22 (step S88). The application section 28 previews the transmitted normal image on the display section 29 on the application software 22 (step S90).

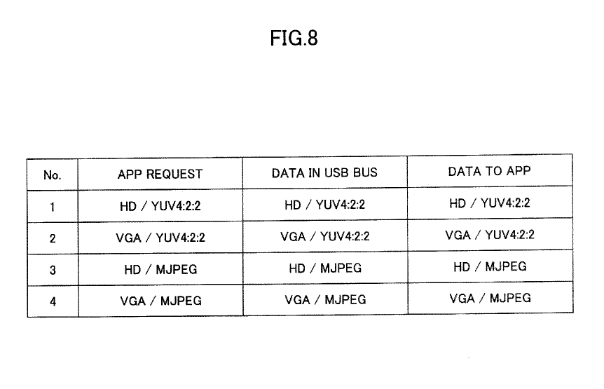

FIG. 8 is a table illustrating the image sizes/image formats of the data transmitted in normal image mode. According to this table, in response to the APP request (which may also be referred to as a “request of the application section 28”), the image size/image format same as those based on the APP request are transmitted on the USB bus and to the APP without any scale conversion or format conversion.

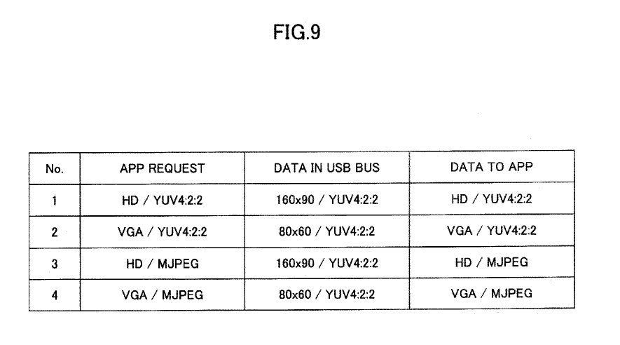

On the other hand, as illustrated in FIG. 9, in a case where the mosaic image mode is selected (step S76), when the mosaic image having, for example, an 8 by 8 pixel tile size is to be output, the firmware (the control section 16) transmits the image data to the USB bus 30, and the acquisition section 23 acquires the transmitted image (step S80). The scale conversion section 24 of the driver software 21 (the scale-up function of the driver software 21 in FIG. 5) simply enlarges the acquired image by eight times in both vertical and horizontal directions (step S82).

After the enlargement of the image, it is determined whether necessary to convert the image format (step S84). When the image format based on the request of the application section 28 is YUV4:2:2, the format conversion section 25 (the MJPEG conversion function of the driver software 21 in FIG. 5) determines that the format conversion of the image is not necessary, and directly transmits the image data to the application software 22 (step S88). By doing this, the mosaic image having 8 by 8 pixels in accordance with the image size/image format requested by the application section 28 is previewed on the application software 22 (step S90).

On the other hand, after the enlargement of the image, when the image format based on the request of the application section 28 is MJPEG, the format conversion section 25 determines that the format conversion of the image is necessary. Then, after encoding the image data to the MJPEG (step S86), the format conversion section 25 transmits the encoded image data to the application section 28 (step S88). By doing this, the mosaic image having 8 by 8 pixels in accordance with the image size/image format requested by the application section 28 is previewed on the application software 22 (step S90).

So far, the image processing and the display operation of the display system 1 have been described. Next, the data output by the USB camera device 12 and on the USB bus 30 are described. When the image size requested by the application software 22 is VGA (640 by 480) and the 8 by 8 pixel tile size is also requested, the size of the image data output from the USB camera device 12 to be transmitted on the USB bus 30 is calculated based on the following formulas. Further, the scaling circuit (not shown) in the video block 13 is used to transmit the YUV4:2:2 image data having the predetermined size to the USB bus 30. For example, based on the following calculation results, the scaling circuit enlarges the transmitted image data to be 640 by 480 pixel data. In this case, a mosaic image is formed having 80 by 60 blocks in the horizontal and the vertical directions, respectively, where consecutive 8 dots in the horizontal direction (horizontal tile size) by consecutive 8 dots in the horizontal direction (vertical tile size) are regarded as one unit block.
Horizontal scale: 640(requested horizontal size)/8(horizontal tile size)=80
Vertical scale: 480(requested vertical size)/8(vertical tile size)=60

By doing this, the acquisition section 23 acquires the image data having the predetermined image size. The term “YUV4:2:2” refers to one of the YUV pixel formats.

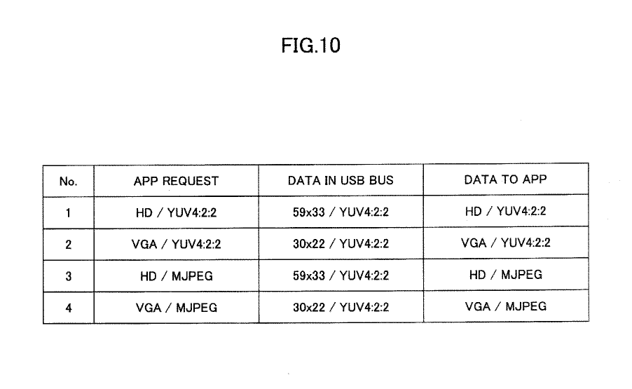

Further, in a case where the mosaic image mode is selected, when, for example, a mosaic image having, for example, 22 by 22 pixel tile size is to be output, as illustrated in the state of the USB data in the mosaic image mode of FIG. 10, the image data are transmitted from the USB camera device 12 to the USB bus 30 in accordance with the request of the application section 28, and are acquired by the acquisition section 23.

The scale conversion section 24 of the driver software 21 simply enlarges the acquired image by 22 times in the horizontal and the vertical directions, and directly transmits the enlarged image data to the application section 28 without any format conversion when the image format requested by the application section 28 is YUV4:2:2.

On the other hand, when the image format requested by the application section 28 is MJPEG, the image data encoded into the MJPEG by the scale conversion section 24 are transmitted to the application section 28. By doing this, the mosaic image having a 22 by 22 pixel tile size may be previewed on the application software 22.

However, as illustrated in FIG. 10, when the data on the USB bus are enlarged by 22 times, the converted image may have the image size greater than that requested by the application section 28. Therefore, a part of the image data having the YUV4:2:2 image format is cut off so that image data have the image size requested by the application section 28. Here, the image data output from the USB camera device 12 and transmitted to the USB bus 30 are calculated using the following formulas by the firmware/software of the USB camera device 12 when the requested size is VGA (640 by 480). Then, the scaling circuit (not shown) in the video block 13 is used to transmit the YUV4:2:2 image data having the predetermined size to the USB bus 30.
Horizontal scale: 640 (requested horizontal size)/22 (horizontal tile size)=30 (calculation result: 29.09)
Vertical scale: 480 (requested vertical size)/22 (vertical tile size)=22 (calculation result: 21.81)

However, as described above, when the calculation result is indivisible by an integer, the result is rounded out. For example, when the calculation result includes a decimal value such as 29.01 (horizontal) or 21.81 (vertical) as described above, the scaling circuit uses round-up values 30 (horizontal) and 22 (vertical) for scaling the image. In this case, the image data may become somewhat more enlarged than the requested image data. Therefore, the application section 28 cuts off an unnecessary part of the image data so that the image data are displayed at the requested scale on the display section 29.

### Effect

As described above, in the display system 1 according to an embodiment, by changing the firmware/software (corresponding to the control section 16) controlling the USB camera device 12 in the (general) USB camera 10 and the driver software (corresponding to the control section 27) for the USB camera 10 and in the PC system 20, it may become possible to configure this system. Therefore, in the display system according to this embodiment, it is not necessary to add hardware to realize the mosaic function to display a mosaic image if desired without increasing the cost of the system while maintaining the manufacturing cost. As a result, privacy of an individual may be protected.

Further, in the display system 1 according to an embodiment, a mosaic image may be displayed without transmitting the normal image in the USB bus 30. Accordingly, it is not possible to steal the normal image from the USB bus 30 by malicious software. As a result, the security may be enhanced.

Further, it may become possible to transmit YUV4:2:2 data having a size less than that of a normal image to the USB bus 30 and perform the enlargement process and MJPEG encode process on the transmitted image data. Therefore, again, it is not necessary to add hardware; therefore the cost of the display system 1 is not increased. Further, it may become possible to display a mosaic image while reducing the processing amount of the image processing of the driver software 21 and reducing the workload of the process. Accordingly, it may become possible to protect individual's privacy in the displayed image.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

The functions of the information processing apparatus according to an embodiment may be realized by software including a group of programs corresponding to the functions. Further, the functions of the information processing apparatus according to an embodiment may be realized in hardware as a semiconductor device such as an LSI (Large Scale Integration) chip including the corresponding functional blocks, or may be realized by a combination of the software and the hardware.

The program to execute the functions of the devices may be stored in a storage unit (not shown) such as a ROM (Read-Only Memory), an HDD (Hard Disk Drive) or the like included in a computer (not shown) in advance. Alternatively, the program may be stored in a non-volatile recording medium such as a CD-ROM (Compact Disc ROM), a flexible disk, an SRAM (Static Random Access Memory), an EEPROM (Electrically Erasable Programmable ROM), a memory card or the like, so that the program stored in the memory may be installed into a computer to cause the CPU to execute the program or so that the CPU is caused to load the program from the memory and execute the program. By any of the methods described above, it may become possible to execute the processes described above with reference to, for example, FIG. 7. Otherwise, the system may be connected to a network so that the program may be downloaded from an external device having a storage medium or a storage unit storing the program.

Further, according to the embodiment described above, there is provided, for example, an information processing system including a device and an information processing apparatus. Further, the device includes a control unit configured to transmit image data. Further, the information processing apparatus includes a receiving unit receiving the image data transmitted from the device, a scale conversion unit enlarging the image data received by the receiving unit in accordance with a requested pixel size, a display unit displaying an image data, and an application unit controlling so as to display the image data on the display unit, the image data having been enlarged in accordance with the requested pixel size by the scale conversion unit.

What is claimed is:

1. An information processing apparatus displaying a desired image, the information processing apparatus comprising:
an acquisition unit configured to acquire image data transmitted from a device connected to the information processing apparatus; and
a scale conversion unit configured to enlarge the acquired image data in accordance with a requested image size.

2. The information processing apparatus according to claim 1,
wherein the scale conversion unit is configured to form a mosaic image based on the image data and in accordance with the requested image size and a predetermined tile size.

3. The information processing apparatus according to claim 1, further comprising:
a format conversion unit configured to convert a format of the image enlarged in accordance with the requested image size.

4. The information processing apparatus according to claim 1,
wherein the acquisition unit is configured to acquire the image data having a changed and predetermined image size.

5. The information processing apparatus according to claim 1, further comprising:
an application unit configured to control so that the image enlarged based on the requested image size is displayed at the requested image size on a display unit.

6. A display method for displaying a desired image in an information processing apparatus, the display method comprising:
acquiring image data transmitted from a device connected to the information processing apparatus;
enlarging the acquired image data in accordance with a requested image size; and
displaying the enlarged image data.

7. The display method according to claim 6, further comprising:
converting a format of the enlarged image in accordance with the requested image size.

8. An information processing system comprising:
a device; and
an information processing apparatus,
wherein the device includes
a control unit configured to transmit image data, and
wherein the information processing apparatus includes
a receiving unit configured to receive the image data transmitted from the device;
a scale conversion unit configured to enlarge the image data received by the receiving unit in accordance with a requested pixel size,
a display unit configured to display an image data, and
an application unit configured to control so as to display the image data on the display unit, the image data having been enlarged in accordance with the requested pixel size by the scale conversion unit.
